(19) United States
(12) Patent Application Publication
(10) Pub. No.: US 2017/0274550 A1
(43) Pub. Date: Sep. 28, 2017

(54) Circle Cutting System

(71) Applicant: Jonathan Potter, JR., Spencer, MA (US)

(72) Inventor: Jonathan Potter, JR., Spencer, MA (US)

(21) Appl. No.: 15/466,086

(22) Filed: Mar. 22, 2017

Related U.S. Application Data
(60) Provisional application No. 62/311,876, filed on Mar. 22, 2016.

(51) Int. Cl. B26F 1/38; E04D 15/00; B26D 7/01; B26D 7/00; B26D 1/25

(52) U.S. Cl. CPC B26F 1/3846; B26D 7/0006; B26D 1/255; B26D 7/015; E04D 15/003

(57) ABSTRACT

A circle cutting system with a blade coupled to a body that rotates and is pressed into sheet material for the separation of circular portions from a larger sheet of the material, such as roofing material.

### CROSS-REFERENCE TO RELATED APPLICATIONS

This application claims benefit from U.S. Provisional Patent Application No. 62/311,876, filed Mar. 22, 2016, the contents of which are incorporated herein by reference.

### BACKGROUND

This disclosure relates to a circle cutting system designed to separate portions of material from a larger sheet of the material. Sheet material may be used to properly seal roofs on various types of buildings. In many cases the sheet material is secured to roofs with the use of anchors which may be spaced as specified by the manufacturers of the material. When it is time to replace the sheet material, for whatever reason, the removal can be very laborious and difficult as the anchors provide significant resistance to the removal effort. Scraping, tearing, and prying of material to be removed can be immensely difficult and time consuming. A less difficult and more efficient method of removing the sheet material has been needed for quite some time.

### SUMMARY

In one aspect, a circle cutting system includes a body that rotates around a central axis. The body may be turned with a rotational source, such as an electric drill or something on that order, providing rotational drive to the body. The system may also have a base with a center axis around which the body may turn, the center and central axes aligning. The base may remain stationary so that it may be placed upon an intended location of sheet material to be cut. The body may have a blade coupled to it in any location as long as it is capable of moving rotationally with the body as driven by a rotational source. The location of the blade may be adjustable or stationary upon the body. The body may be moved away from and toward the base, parallel to the central axis, thereby moving the blade away from, toward, and into the material intended to be cut. In the preferred embodiment, a user may place the base of the system upon sheet material intended to be cut. A rotational source turns the body around its central axis while the base may remain stationary upon the material intended to be cut, the center axis of the base aligned with the central axis of the body. The user may then apply pressure downward upon the body of the cutting system, thereby pushing the coupled blade downward and into the material on which the base is resting. The rotational movement of the blade may then cut a circular incision in the material. Once the incision separates the incised circle from the sheet of material, the surrounding sheet may be lifted, leaving the separated circular piece of material behind.

Embodiments may include one of the following features, or any combination thereof. In one aspect, the body may include an upper shaft that connects to the rotational source. The upper shaft may be of a variety of lengths and shapes, depending upon the type of rotational source used, the intended material to be cut, and the intended size of the incised circular piece.

In another aspect, the circle cutting system may have a blade arm that may be fixed or adjustable. The blade arm may be coupled to the body and may extend outward from the body central axis with a distal end. The blade arm may have a blade holder securing a blade and the blade arm may be any length that is manageable, as limited by the rotational source, the area available to the user, or the size and location of the sheet material intended to be cut.

In another embodiment, a second blade arm may be coupled to the body. The second arm may be fixed or adjustable and it may extend outward from the body central axis with a distal end. The second blade arm may have a second blade holder securing a second blade and the second blade arm may be any length that is manageable, as limited by the rotational source, the area available to the user, or the size and location of the sheet material intended to be cut. With this embodiment, the user may choose to locate the first blade and the second blade at equal distances from the central axis so that a desired incised circle may be cut more quickly than if there were just one blade. The user may also wish to locate the two blades at different lengths relative to the central axis of the body, therefore capable of cutting circles in the material of two different sizes, as preferred by the user. Using the cutting system with two blades, each at different lengths from the central axis, results in a doughnut shaped remnant upon removal of the sheet from which it is cut. This feature could be of use in a variety of other uses of the circle cutting system.

In yet another embodiment, the circle cutting system may also comprise a lower shaft interfacing with the base and extending upward and fitting into a bore within a lower portion of the body. The body may be slidably and rotationally moved upon the lower shaft, allowing the base to remain stationary upon the sheet material intended to be cut.

In one aspect, a spring may be featured between the body and the lower shaft of the circle cutting system. Therefore, when a user pushes down upon the body, the spring may compress while simultaneously allowing the body to rotate freely upon the lower shaft, their axes remaining in alignment. This feature allows for a gradual lowering of the blade into the sheet material and a simple removal of the blade from the material once the circular incision has been completed.

Another embodiment of the circle cutting system may include at least one ball bearing between the lower shaft and the base so that the body and lower shaft may rotate more freely on the base. Other methods and/or devices may be utilized to achieve similar reductions in friction between the lower shaft and the base in order to allow the body to move as freely as possible on or around the base so that the rotational drive may be optimized for cutting rather than overcoming inherent system friction. In the preferred embodiment, the bearing resides as close as possible to the bottom of the circle cutting system. This provides a more significant distance for the body, and hence the blade, to travel toward the base, keeping the blade clear of the sheet material when cutting is not yet intended.

In another aspect, a key may be featured within a key slot that has a length parallel to the central axis of the body. The key slot may be located in a variety of locations on the body and the key may be installed or removed from the key slot. When the key is installed, it is inserted through the body, within the key slot, and likewise through a hole in the lower shaft, coupling the two together. The key may fit snugly through the lower shaft, but the key may move freely within the key slot in the body, allowing the body to move away from, and toward, the material intended to be cut. However, the shape of the slot does not permit the body to rotate distinctly from the lower shaft when the key is installed. Therefore, when the key is installed through the lower shaft within the key slot, rotational energy provided to the body is directly transferred to the lower shaft. This embodiment of the cutting system requires the bearing between the base and the lower shaft so that the cutting system has a stationary base beneath a rotating body. The key and key slot allow the body to be slidably independent from the lower shaft within the length of the key slot, but rotationally secured to the lower shaft. The installed key also provides stability for the circle cutting system while it is being stored or transported. Although the blade may be protected by a guard of some sort, the installed key inhibits the rotation of the body and the lower shaft, with respect to each other, minimizing the chances of injury or damage to the blade while moving or storing the system. When the key is removed, the body and lower shaft become slidably and rotationally independent.

In another aspect, the circle cutting system may include a magnet attached to the base in some fashion. The magnet assists the user in finding the locations of metal anchors which are attached to sheet materials in applications such as roofs. The magnet on the base is attracted to the metal anchor, so the user may easily and precisely place the base of the circle cutting system directly above the material attached to the anchor. Downward force from the user toward the material, and rotational drive from the rotational source upon the body, allows the blade to cut a circle in the material with a radius chosen by the user in the location of the blade or blades relative to the central axis of the body.

In another embodiment of the circle cutting system, a plate/shield/guard may be positioned above, around, or in any location near or ahead of the blade to prevent the blade from accidentally hitting any objects in the path or deflecting material away from the area being cut.

### BRIEF DESCRIPTION OF THE DRAWINGS

FIG. 1 is a perspective view of a circle cutting system.

FIG. 2 is a top view of a circle cutting system.

FIG. 3 is a cross-section along line 3-3 of FIG. 2.

FIG. 4 is a cross-section of an alternative example, similar to that of FIG. 3.

FIG. 5 is a cross-section of an alternative example, similar to that of FIG. 3.

FIG. 6 is a cross-section of an alternative example, similar to that of FIG. 3.

### DETAILED DESCRIPTION

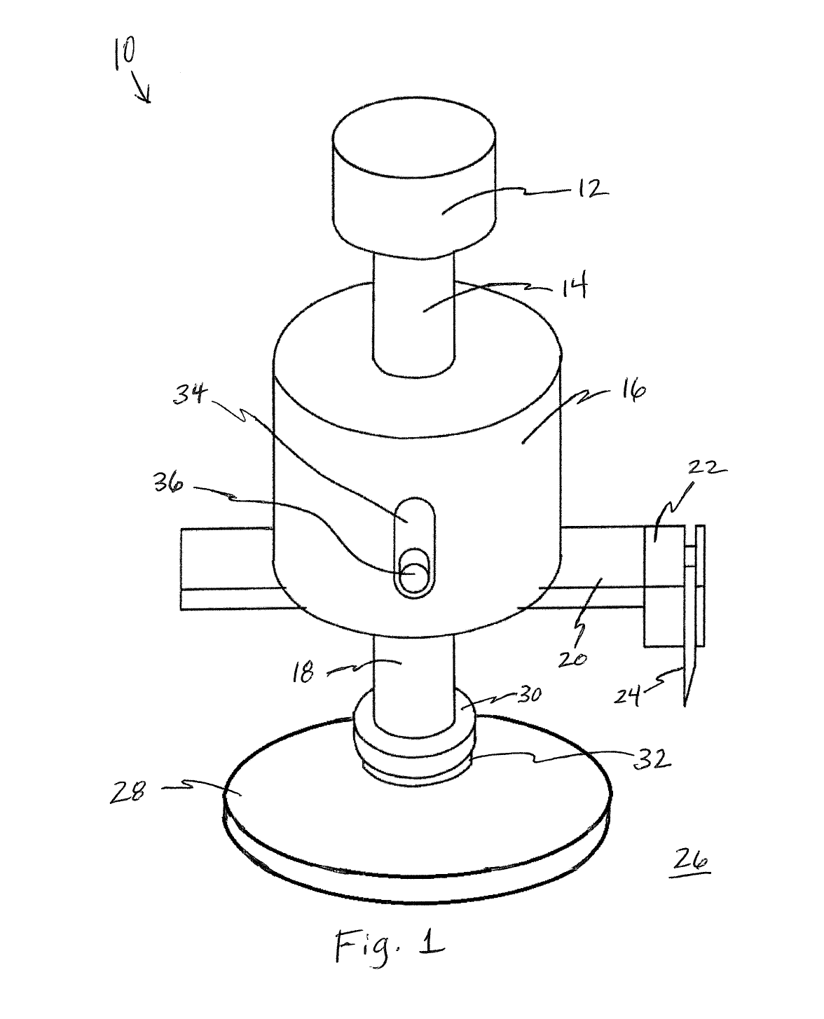

FIG. 1 shows circle cutting system 10 with driver 12 which provides rotational energy to system 10. Driver 12 could be an electric drill with or without a cord (not shown), or something on that order, for example. This embodiment includes upper shaft 14 of body 16, and lower shaft 18 emerging from beneath body 16. Blade arm 20 extends laterally from body 16 with blade holder 22 coupled to the distal end of blade arm 20. Blade min 20 is coupled to body 16 and its length to its distal end may be fixed or adjustable. Blade 24 is secured within blade holder 22, pointing downward toward sheet material 26 intended to be cut. Lower shaft 18 interfaces with the top of base 28 through ball bearing cover 30 and ball bearing 32. This allows lower shaft 18 to turn freely while the bottom of base 28 remains stationary upon sheet material 26. Key slot 34 extends through body 16 and key 36 is installed within slot 34, likewise extending through body 16. Bearing 32 allows base 28 to remain stationary while lower shaft 18, body 16, and therefore blade 24, rotate as driven by driver 12. Key 36, installed within key slot 34, allows rotating body 16 to move toward base 28 when downward pressure is applied upon driver 12 and upper shaft 14 by a user. Cutting system 10 allows a user to press downward upon body 16, extending blade 24 into sheet material 26 so that a circle may be cut into various types and sizes of sheet material 26 on top of commercial roofs, for example. The material incised from the sheet material 26 is typically adhered to some sort of metal anchor on the roof. Cutting away the portions that are adhered to such anchors allows one to remove the larger sheet of material from which the portions were cut, and leaving the incised circles of remnant sheet material behind and still adhered to the roof. This eliminates much of the efforts used presently in scraping, tearing, and prying of existing roofing material so that new roofing may be installed

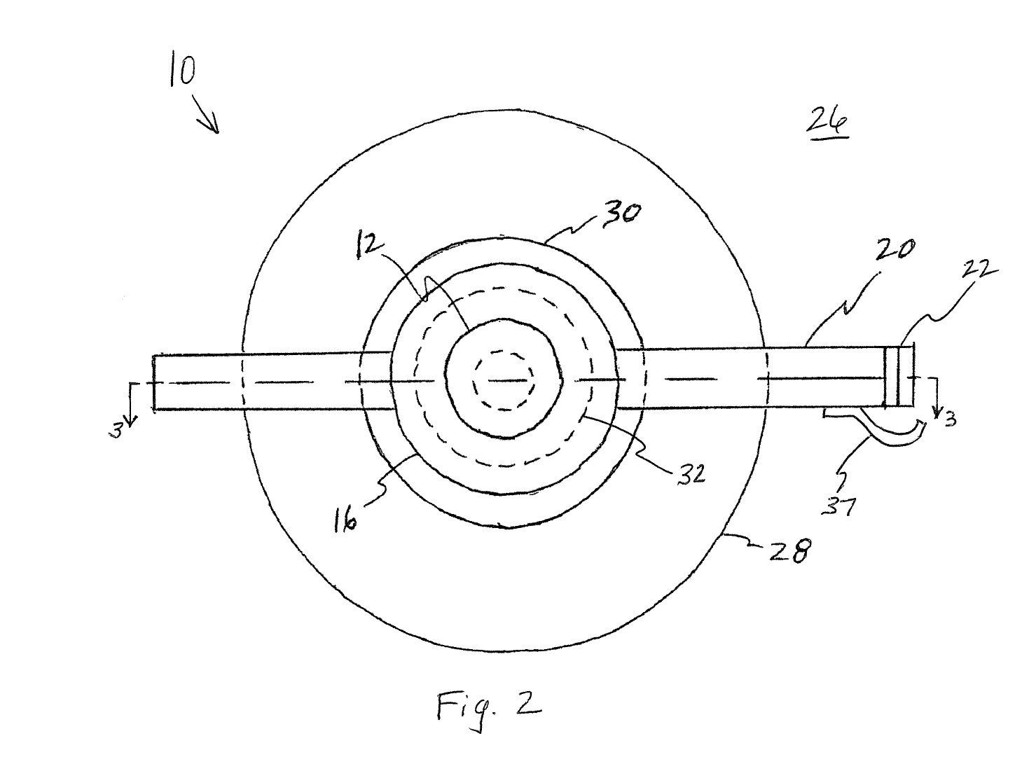

FIG. 2 shows a top view of circle cutting system 10 shown in FIG. 1 depicting driver 12, body 16, blade arm 20, blade holder 22, base 28, bearing cover 30, bearing 32, and sheet material 26. When system 10 is in use, base 28 rests on sheet material 26 intended to be cut. Driver 12 turns body 16, and hence blade holder 22 with blade 24 (not shown) also turn in a circle. A user may push driver 12 toward sheet material 26, lowering blade 24 into sheet material 26, incising a circle in the sheet material. Blade shield 37 is shown near blade holder 22 and is used to deflect material which may scatter once cutting of sheet material has begun. Blade shield 37 may be of any shape or size and can be located anywhere upon circle cutting system 10. After the incision, sheet material 26 may be removed, leaving the incised circle remaining adhered to the roof or other surface.

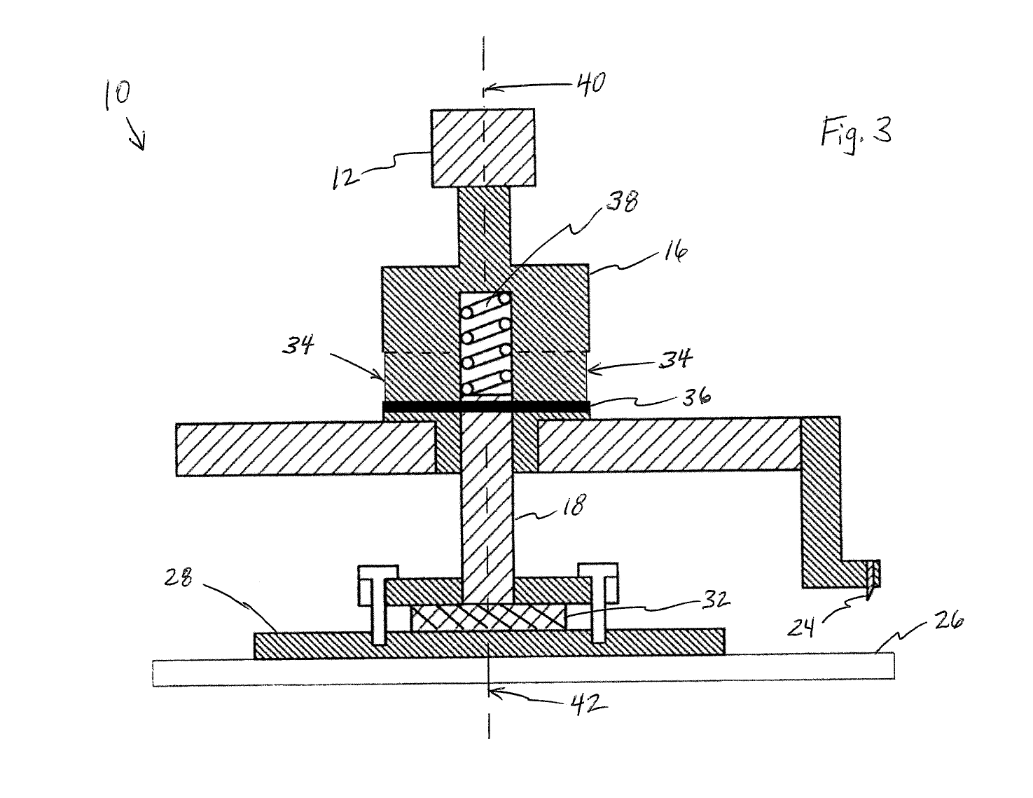

FIG. 3 shows a cross-sectional view of circle cutting system 10 as viewed along the line 3-3 in FIG. 2. Lower shaft 18 is positioned in a bore within body 16 and spring 38 is located between lower shaft 18 and body 16 with a slightly compressed configuration biasing body 16 upward, away from base 28 and sheet material 26. Therefore, in its resting state, cutting system 10 positions blade 24 above and away from sheet material sheet 26 with the bias of spring 38. The slight compression on spring 38 is maintained through the coupling of body 16 and lower shaft 18 with key 36. Body 16 is at its highest position away from sheet material 26 with key 36 in contact with the bottom of key slot 34. Key 36 extends through, and is coupled to, lower shaft 18. Key slot 34 allows body 16 to move freely toward and away from base 28 and sheet material 26. The vertical length of key slot 34 provides a maximum depth to which body 16 may plunge, thereby limiting the depth to which blade 24 may cut into sheet material 26. The vertical length of key slot 34 also provides a maximum height to which spring 38 may push body 16 away from lower shaft 18. When key 36 is installed through a hole (not shown) in lower shaft 18 so that lower shaft 18 is rotationally secured to body 16. Therefore, both body 16 and lower shaft 18 rotate together when a rotational drive is applied to upper shaft 14 from driver 12. This requires the use of bearing 32 so that base 28 may remain stationary upon sheet material 26 intended to be cut. Circle cutting system 10 requires the use of bearing 32 only when key 36 is installed. System 10 functions with or without bearing 32 if key 36 is not installed as body 16 and base 28 are slidably and rotationally independent without the use of key 36. Body 16 rotates around central axis 40 which is aligned with center axis 42 of base 28. Cutting system 10 allows a user to cut holes in sheet material 26 at all anchor locations on a commercial roof so that sheet material may be easily rolled and removed, leaving incised circles, each cut with circle cutting system 10, remaining and adhered to existing roof anchors (not shown).

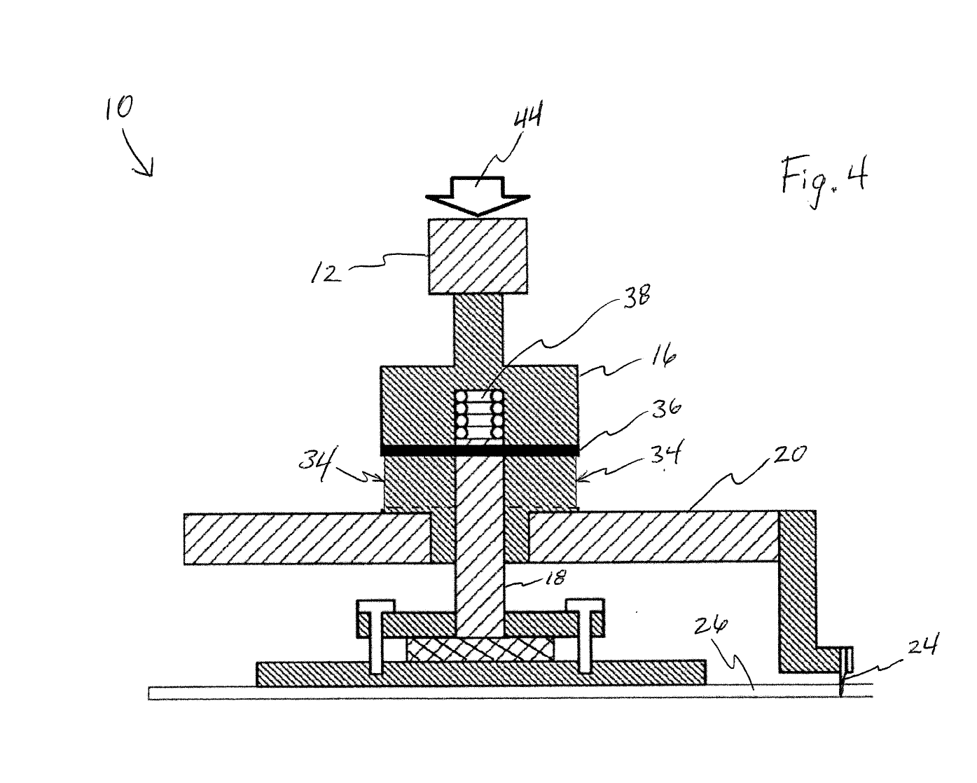

FIG. 4 is the cross-section of circle cutting system 10 as depicted in FIG. 3 but with downward force 44 placed on rotational driver 12 and hence on body 16 which compresses spring 38 inside body 16. This configuration of system 10 shows body 16 extending further over lower shaft 18, thereby pushing blade arm 20 down and blade 24 into sheet material 26. As body 16 rotates due to forces asserted by driver 12, blade arm 20 moves blade 24 around in a circle and cuts a circle (not shown) in sheet material 26. Body 16 is shown in its lowest position with key 36 in contact with the top of key slot 34.

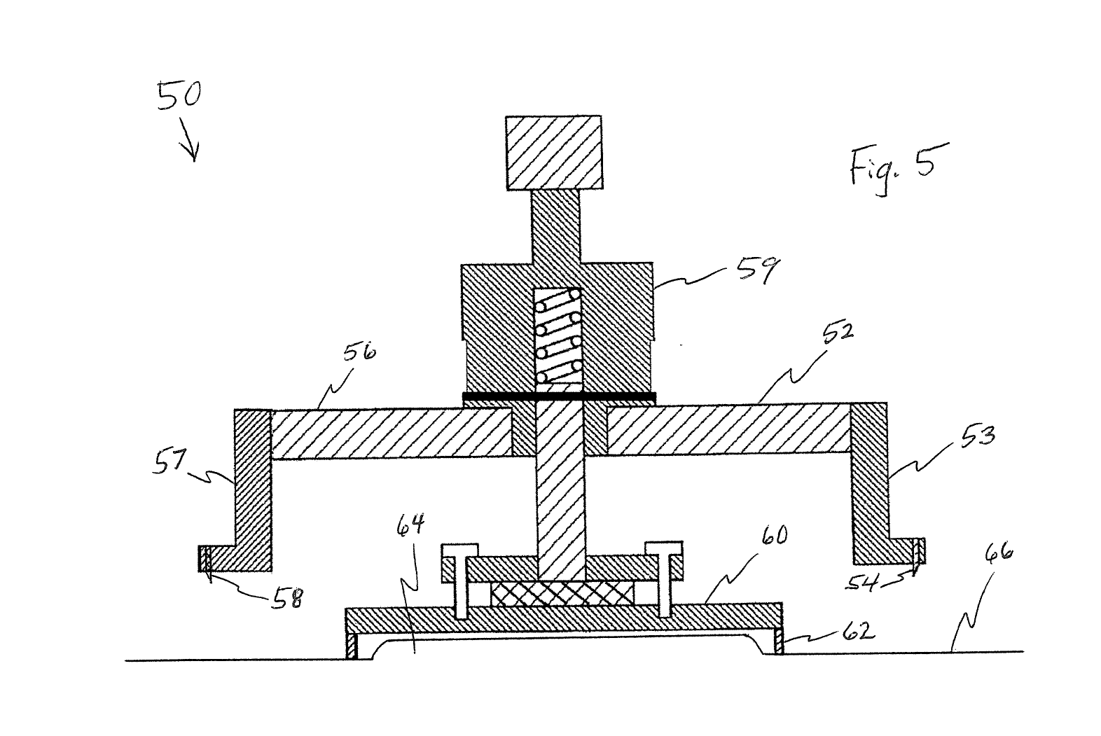

FIG. 5 is a cross-section of circle cutting system 50 with first blade aim 52, first blade holder 53, first blade 54, second blade arm 56, second blade holder 57, second blade 58, and elevated base 60 with added spacer 62 to fit over a raised texture or surface 64 so that cutting system 50 rests evenly upon the sheet material 66 before cutting begins. Second blade holder 57 is coupled to the distal end of second blade arm 56 and second blade 58 is secured to second blade holder 57. Second blade arm 56 is coupled to body 59 and its length to its distal end may be fixed or adjustable. Use of two blades 54, 58 in this configuration allows system 50 to cut sheet material 66 with efficiency.

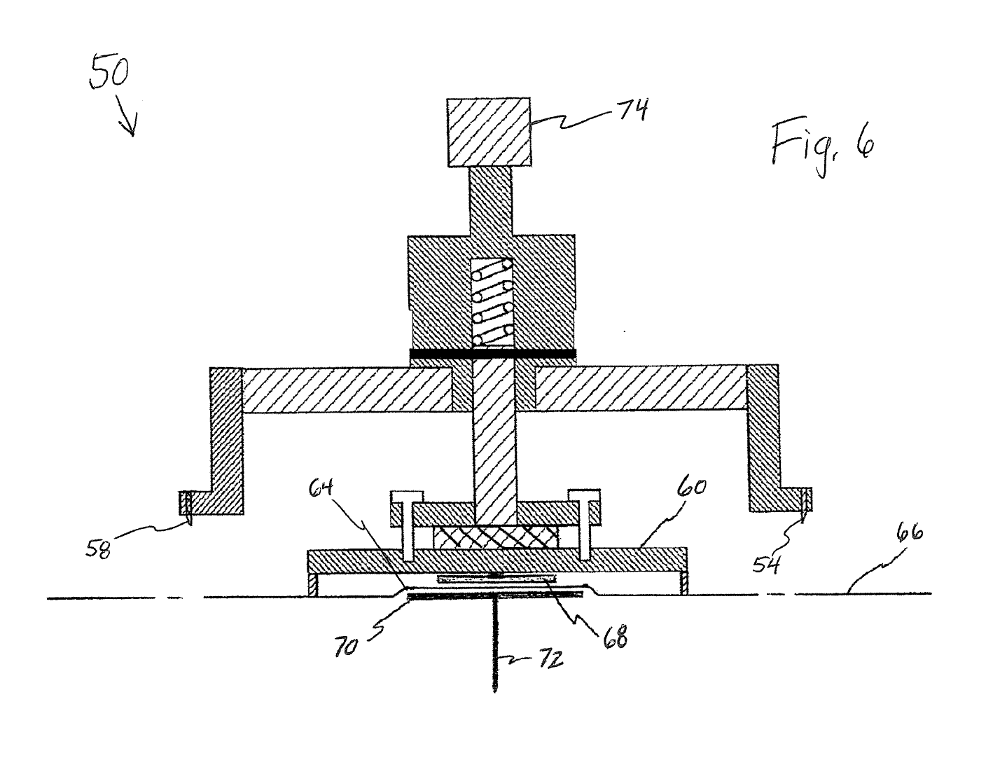

FIG. 6 is a cross-section of circle cutting system 50 as depicted in FIG. 5 with magnet 68 located above roofing anchor 70 with anchor fastener 72 below sheet material 66. Roofing anchors 70 are placed throughout the surface of commercial roofs and are coupled to the roofs with anchor fasteners 72. Sheet material 66 is spread throughout the roof surface and adhered to metal anchors 70 to secure the sheet to the roof. As depicted, magnet 68 is attached to the bottom of base 60 and is used to locate metal anchors 70 when sheet material 66 needs to be removed. Magnet 68 locates the position of each metal anchor 70 and is placed above it as depicted. Then first blade 54 and second blade 58 may cut a circle when rotational energy is asserted to driver 74, and rotating blades 54 and 58 are pressed into sheet material 66. Base 60 fits over raised texture or surface 64, under which anchor 70 is located, in sheet material 66 so that cutting system 50 rests evenly upon the sheet material before cutting begins. Sheet material 66 may then be removed, leaving an incised circle (not shown) behind and still adhered to each metal anchor 70.

A number of implementations have been described. Nevertheless, it will be understood that additional modifications may be made without departing from the scope of the inventive concepts described herein, and, accordingly, other embodiments are within the scope of the following claims.

What is claimed is:

1. A circle cutting system comprising:
a body that rotates around a central axis;
a base with a top, a bottom, and a center axis aligned with the central axis;
a first blade holder; and
a first blade;
wherein the first blade is secured to the first blade holder;
wherein the body rotates on the base;
wherein the first blade holder is coupled to the body so that when the body rotates, the first blade rotates in a circle that is perpendicular to the central axis, the circle having a center on the central axis; and
wherein the center of the circle can be anywhere along the central axis from above the top of the base to below the bottom of the base.

2. The circle cutting system of claim 1 further comprising an upper shaft that extends from the body, away from the base, the upper shaft couplable to a rotational drive source.

3. The circle cutting system of claim 1 further comprising:
a first blade aim with a first distal end;
wherein the first blade arm is coupled to the body;
wherein the first blade holder is coupled to the first distal end of the first blade aim; and
wherein the first blade holder is a first distance from the body.

4. The circle cutting system of claim 3 wherein the first blade arm is constructed and arranged so that the first distance is adjustable.

5. The circle cutting system of claim 4 further comprising a second blade arm with a second distal end, wherein the second blade aim is coupled to the body.

6. The circle cutting system of claim 5 further comprising a second blade holder;
wherein the second blade holder is coupled to the second distal end of the second blade arm;
wherein the second blade holder is a second distance from the body; and
wherein the second blade arm is constructed and arranged so that the second distance is adjustable.

7. The circle cutting system of claim 6 further comprising a second blade secured to the second blade holder.

8. The circle cutting system of claim 1 further comprising a lower shaft;
wherein the lower shaft is coupled to the body;
wherein the lower shaft is slidably and rotationally independent from the body; and
wherein the lower shaft interfaces with the base.

9. The circle cutting system of claim 8 further comprising a spring with a spring axis;
wherein the spring is between the body and the lower shaft;
wherein the spring axis is aligned with the central axis of the body; and
wherein the spring compresses along the spring axis when the body and the lower shaft are pressed toward each other.

10. The circle cutting system of claim 9 further comprising;
a key;
a key slot; and
a hole through the lower shaft;
wherein the key can be installed and removed from the key slot and the hole through the lower shaft; and
wherein the lower shaft is rotationally secured to the body when the key is installed.

11. The circle cutting system of claim 10 further comprising a bearing between the base and the lower shaft to allow smooth rotation where the lower shaft interfaces with the base.

12. The circle cutting system of claim 1 further comprising a magnet coupled to the base.

13. The circle cutting system of claim 1 further comprising a spacer coupled to the bottom of the base to make a space for a textured surface under the base.

14. The circle cutting system of claim 1 further comprising a blade shield used to deflect scattering material while cutting is occurring;
wherein the blade shield may be of various sizes and shapes; and
wherein the blade shield may be located anywhere upon the circle cutting system.

15. A circle cutting system comprising:
a body that rotates around a central axis;
an upper shaft;
a first blade arm with a first distal end;
a first blade holder;
a lower shaft with a hole through it;
a base with a top, a bottom, and a center axis aligned with the central axis;
a first blade;
a spring with a spring axis;
a key;
a key slot; and
a bearing;
wherein the upper shaft extends from the body and is couplable to a rotational drive source;
wherein the first blade arm is coupled to the body;
wherein the first blade holder is coupled to the first distal end of the first blade arm;
wherein the first blade holder is a first distance from the body, the first distance being adjustable;
wherein the first blade is secured to the first blade holder;
wherein the lower shaft is coupled to the body;
wherein the lower shaft is slidably and rotationally independent from the body;
wherein the spring is between the body and the lower shaft;
wherein the spring axis is aligned with the central axis of the body;
wherein the spring compresses along the spring axis when the body and the lower shaft are pressed toward each other; and
wherein the lower shaft is rotationally secured to the body when the key is installed in the key slot and through the hole in the lower shaft wherein the lower shaft rotates on the base;
wherein the first blade rotates in a circle that is perpendicular to the central axis when the body rotates, the circle having a center on the central axis; and
wherein the center of the circle can be anywhere along the central axis from above the top of the base to below the bottom of the base.

16. The circle cutting system of claim 15 further comprising a second blade arm with a second distal end, wherein the second blade arm is coupled to the body.

17. The circle cutting system of claim 16 further comprising a second blade;
wherein the second blade holder is coupled to the second distal end of the second blade arm;
wherein the second blade holder is a second distance from the body; the second distance being adjustable; and
wherein the second blade is secured to the second blade holder.

18. The circle cutting system of claim 17 further comprising a spacer coupled to the bottom of the base to make a space for a textured surface under the base.

19. The circle cutting system of claim 18 further comprising a magnet coupled to the base.

20. The circle cutting system of claim 19 further comprising a blade shield used to deflect scattering material while cutting is occurring;
